(19) United States
(12) Patent Application Publication
(10) Pub. No.: US 2018/0222206 A1
(43) Pub. Date: Aug. 9, 2018

(54) FLUID SEALS

(71) Applicant: HEWLETT-PACKARD DEVELOPMENT COMPANY, L.P., Houston, TX (US)

(72) Inventors: Patrick V. Boyd, Corvallis, OR (US); Mike M. Morrow, Corvallis, OR (US); Brad Benson, Corvallis, OR (US)

(73) Assignee: HEWLETT-PACKARD DEVELOPMENT COMPANY, L.P., Houston, TX (US)

(21) Appl. No.: 15/747,684

(22) PCT Filed: Sep. 30, 2015
(86) PCT No.: PCT/US2015/053177

§ 371 Date: Jan. 25, 2018

(51) Int. Cl. B41J 2/175; F16L 17/06

(52) U.S. Cl. CPC B41J 2/175; F16J 15/02; F16L 17/063

(57) ABSTRACT

A fluid seal may comprise an external sealing body, and an internal sealing body disposed within the external sealing body. The internal sealing body may be radially connected to the external sealing body by a webbing. Further, the external sealing body may hermetically seal a fluid path from the exterior of the fluid path, while the internal sealing body may hermetically seal the fluid path from within the interior of the fluid path.

### BACKGROUND

Printing devices may use ink supplies to supply ink to the device, so that the ink may then be deposited on a print medium. The ink supplies may include fluid reservoirs, which may be in fluid communication with other components of the ink supply. Further, the ink supply may be in fluid communication with the printing device. The fluid pathways in such an ink supply or printing device may include junctions, where one component of the fluid pathway is in fluid communication with another, separate component.

### BRIEF DESCRIPTION OF THE DRAWINGS

FIG. 1A is a perspective view of an example fluid seal as described herein.

FIG. 1B is a cross-sectional view of an example fluid seal, taken along view line 1B-1B as described herein.

FIG. 2A is a cross-sectional view of a fluid sealing system including an example fluid seal as described herein.

FIG. 2B is a cross-sectional view of a fluid scaling system including an example fluid seal as described herein.

### DETAILED DESCRIPTION

Printing devices may use ink supplies to supply ink to the device, so that the ink may then be deposited on a print medium. The ink supplies may include fluid reservoirs, which may be in fluid communication with other components of the ink supply. Further, the ink supply may be in fluid communication with the printing device. The fluid pathways within such an ink supply or printing device may include junctions, where one component of the fluid pathway is in fluid communication with another, separate component. Such a junction may include one fluid orifice mating with another fluid orifice. Further, such a junction may include a sealing component to prevent fluid within such a junction from escaping from the fluid pathway and permeating throughout the rest of the ink supply or container, the printing device, or to the external environment.

In some situations, the ink supply or printing device, or the fluid pathways therein, may experience an external or internal event that may cause an increase or spike in the pressure of the fluid within the fluid pathways of the ink supply or printing device. Such an event may include an external impact or other environmental stress or condition, such as temperature changes, for example, sufficient to cause such a pressure spike. Such a pressure spike may be severe enough to temporarily deform the scaling component, therefore overcoming the sealing force of the sealing component at a junction in a fluid pathway of the ink supply or printing device. In such a situation, the fluid within the fluid pathway may be able to circumvent the scaling component and escape from the fluid pathway.

Implementations of the present disclosure provide a fluid seal that can seal a junction in a fluid pathway from both the exterior of the fluid pathway, as well as the interior. Further, the example fluid seals disclosed herein may prevent fluid from escaping the fluid pathway upon a pressure spike in the fluid from an external or internal event. Yet further, such a pressure spike may increase the scaling ability of the fluid seals disclosed herein within the interior of the fluid pathway.

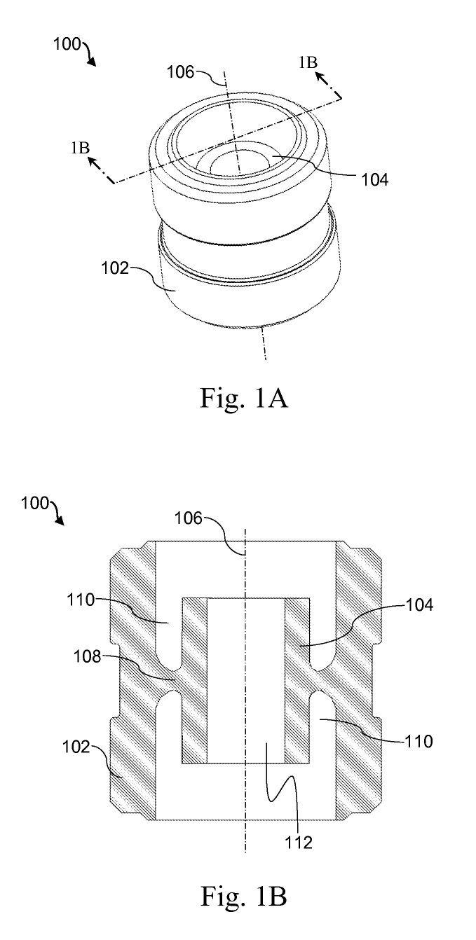

Referring now to FIG. 1A, a perspective view of an example fluid seal 100 is illustrated. Fluid seal 100 may include an external sealing body 102 and an internal sealing body 104. Sometimes the external and internal sealing bodies 102 and 104 may each be referred to as a boot seal, or sealing boot. Referring additionally to FIG. 1B, a cross-sectional view of an example fluid seal 100, taken along view line 1B-1B, is illustrated. In some implementations, the fluid seal 100 may also include a connecting portion 108, such as a webbing or another piece of material connecting the external scaling body 102 to the internal scaling body 104. In some implementations, the external scaling body 102, the internal sealing body 104, and the connecting portion 108 may comprise a unitary piece of material. The fluid seal 100, in some implementations, may be molded as one piece during manufacturing, or, in other words, the fluid seal 100, starting as a liquid or in another pliable state, may be formed using a rigid frame or mold. In other implementations, the fluid seal 100 may be machined out of a solid piece of material. The fluid seal 100 may also be formed by a combination of molding and machining, in some implementations. In further implementations, the external sealing body 102, the internal sealing body 104, and the connecting portion 108 may each comprise a separate component that may be mechanically assembled and fastened to the other components of the fluid seal 100. The external sealing body 102 and the internal scaling body 104 may each comprise a material suitable for creating a hermetic seal against another surface. In this context, hermetic seal may refer to a seal that may range from 100% tight, thereby preventing gaseous fluids from passing through, to tight enough such that a liquid fluid, such as printing ink, may not pass through the seal. The material may be suitable for creating a hermetic seal with a metallic or polymer surface. In some implementations, the connecting portion 108 may also comprise such a material. In further implementations, the fluid seal 100, or each of the components therein, may comprise a polymer material, or, further, an elastomer material.

In some implementations, the external sealing body 102 may have a longitudinal axis 106 that extends the length of the fluid seal 100. The external scaling body 102 may have a tubular construction, with an opening or aperture at either end. In further implementations, the internal sealing body 104 may be disposed within the external sealing body 102. In yet further implementations, the internal sealing body 104 may be disposed such that it is concentric to the external sealing body 102, or, in other words, the internal sealing body 104 may share the same longitudinal axis 106 as the external sealing body 102. In some implementations, one or both of the external and internal sealing bodies 102 and 104 may comprise a cylindrical barrel or cylindrical tubular geometry. The internal scaling body 104 may be radially connected to the external scaling body 102 by the webbing 108. In other words, the connecting portion 108 may extend radially from the internal sealing body 104 to the external sealing body 102. The connection portion 108 may, in some implementations, be disposed along a plane that bisects the fluid seal 100. In such an implementation, the internal scaling body 104 may extend along the longitudinal axis 106 in both directions from the connecting portion or webbing 108. In further implementations, the fluid seal 100 may be asymmetrical, or, the connecting portion 108 may be disposed along the longitudinal axis 106 in a location other than a central, bisecting location. In other words, the internal scaling body 104 may extend along the longitudinal axis 106 from the connecting portion 108 further on one side of the connection portion 108 than on the opposing side of the connecting portion 108.

The internal sealing body 104 may be disposed within the external sealing body 102 such that there is a gap, space, cavity, or other absence of material 110 in between the internal and external sealing bodies. Such a cavity 110 may be present on one or both sides of the connecting portion 108, and may, further, be of a uniform width in between the external and internal sealing bodies 102 and 104 throughout the entire circumference or perimeter of the internal sealing body 104. In other words, the internal sealing body 104 may extend along the longitudinal axis 106 in both directions from the connecting portion or webbing 108 such that the internal sealing body 104 defines a cavity in between the internal sealing body 104 and the external scaling body 102 on one side of the connecting portion 108, and further defines an opposing cavity between the internal sealing body 104 and the external sealing body 102 on the opposing side of the connecting portion 108. Additionally, the fluid seal 100 may have a central cavity or bore 112 within the internal sealing body 104. The central cavity 112 may extend through the entire internal sealing body 104 along the longitudinal axis 106. Further, the central cavity 112 may be suitable for a fluid to pass through the length of the cavity.

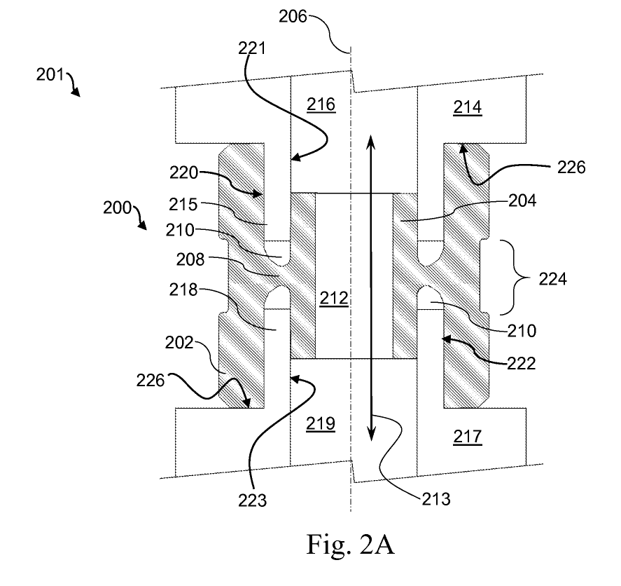

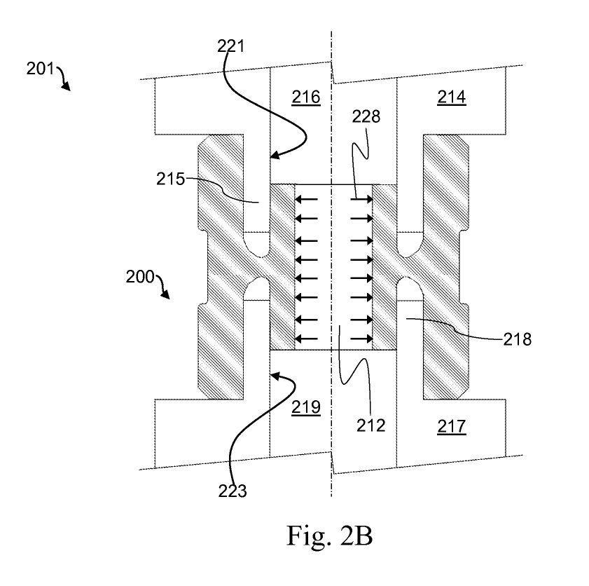

Referring now to FIG. 2A, a cross-sectional view of an example fluid sealing system 201 including an example fluid seal 200 is illustrated. Example fluid seal 200 may be similar to example fluid seal 100. Further, the similarly named elements of example fluid seal 200 may be similar in function and/or structure to the elements of example fluid seal 100, as they are described above. The example fluid seal 200 may include an external sealing body 202, an internal sealing body 204, and a connecting portion or webbing 208. The example fluid seal 200 may also include a longitudinal axis 206, in some implementations. Further, the fluid sealing system 201 may include a first fluid tube 214, as well as a second fluid tube 217, in addition to the example fluid seal 200. The first and second fluid tubes 214 and 217, in some implementations, may be components within a larger fluid system, such as a printing device, for example an ink-jet printer, or an ink cartridge for use in a printing device, or other type of ink supply or container. The first and second fluid tubes 214 and 217 may, further, be plumbing components to carry fluid within such a larger system. In some implementations, one or both of the fluid tubes 214 and 217 may be in fluid communication with a fluid reservoir, which may be an ink reservoir, within the larger fluid system. In further implementations, the first and second fluid tubes 214 and 217 may be in fluid communication with one another through the example fluid seal 200. The fluid seal 200 may enable a hermetic seal between the first and second fluid tubes 214 and 217 such that the fluid within, which may be printing ink in some implementations, may travel from the first fluid tube 214 to the second fluid tube 217, or vice versa.

The first fluid tube 214 may include a first fluid orifice 215 through which fluid may travel from a first fluid cavity 216 within the first fluid tube 214. Similarly, the second fluid tube 217 may include a second fluid orifice 218 through which fluid may travel from a second fluid cavity 219 within the second fluid tube 217. The first and second fluid orifices 215 and 218 may have a generally tubular structure, in some implementations. The example fluid seal 200 may have an interior profile that may share the same cross-sectional geometry as the first and second fluid orifices 215 and 218, such that each of the fluid orifices 215 and 218 may be inserted into the fluid seal 200. In further implementations, the fluid seal 200 may have an interior profile with a generally cylindrical geometry to match and complement a cylindrical tubular cross-sectional geometry of the fluid orifices 215 and 218. Further, the first and second fluid orifices 215 and 218 may each have a longitudinal axis 206, and in some implementations, may share the same longitudinal axis 206 such that the orifices are disposed concentrically to each other. The second fluid orifice 218 may be concentrically aligned with the first fluid orifice 218 such that the first and second fluid orifices 215 and 218, in conjunction with a central cavity 212 of the fluid seal 200, define a fluid path between the first and second fluid tubes 214 and 217, as represented by the bidirectional arrow 213 of FIG. 2A. The fluid path 213 may enable fluid communication between the first fluid cavity 216 of the first fluid tube 214, and the second fluid cavity 219 of the second fluid tube 217. The fluid path may be further defined by an exterior surface 220 and an interior surface 221 of the first fluid orifice 215, as well as an exterior surface 222 and an interior surface 223 of the second fluid orifice 218. The fluid path may include a junction 224 at which the first and second fluid orifices 215 and 218 engage with each other through the fluid seal 200. Such a junction 224 may include the engagement of each of the first and second fluid orifices 215 and 218 with the example fluid seal 200.

The first and second fluid orifices 215 and 218 may be inserted into the example fluid seal 200 as illustrated in FIG. 2A. The first and second fluid orifices 215 and 218 may extend into the fluid seal 200 from opposing sides of the fluid seal 200. In some implementations, the first fluid orifice 215 may extend into a cavity 210 disposed in between the internal sealing body 204 of the fluid seal 200 and the external sealing body 202 of the fluid seal 200 on one side of the connecting portion or webbing 208. Further, the second fluid orifice 218 may extend into a cavity 210 disposed in between the internal sealing body 204 of the fluid seal 200 and the external sealing body 202 of the fluid seal 200 on an opposing side of the connecting portion or webbing 208. In some implementations, one or both of the first and second fluid orifices 215 and 218 may engage with the respective cavities 210 through an interference fit. For example, the width of the cavity 210 engaging with the first fluid orifice 215 may be the exact same as or smaller than the thickness of the first fluid orifice 215. Such an interference fit may enable the external sealing body 202 and the internal scaling body 204 to hermetically seal against the respective fluid orifices 215 and 218. In other words, the external scaling body 202 may engage with the exterior surface 220 of the first fluid orifice 215 and the exterior surface 222 of the second fluid orifice 218 such that the external sealing body 202 creates a seal against such surfaces so that fluid within the fluid path cannot escape from the fluid path through the junction 224. In other words, the external scaling body 102 may hermetically seal the fluid path 213 from the exterior of the fluid path. Similarly, the internal sealing body 204 may engage with the interior surface 221 of the first fluid orifice 215 and the interior surface 223 of the second fluid orifice 218 such that the internal scaling body 204 creates a seal against such surfaces so that fluid within the fluid path cannot escape from the fluid path through the junction 224. In other words, the internal scaling body 104 may hermetically seal the fluid path 213 from within the interior of the fluid path 213. In some implementations, the pressure of the fluid within the fluid path may push against and force the internal sealing body 204 against the interior surfaces 221 and 223 to create such a seal to prevent the fluid from escaping the fluid path. Thus, in other words, the fluid within the fluid path is prevented from escaping through the junction 224 by both of the external and internal sealing bodies 202 and 204. Further, the fluid pressure of the fluid itself may help the internal scaling body 204 prevent the fluid from escaping through the junction.

Additionally, in some implementations, the external scaling body 202 of the example fluid seal 200 may abut with and seal against a shoulder portion or other surface of one or both of the fluid tubes 214 and 217. The external sealing body 202 may have a sealing face 226 disposed on each end of the body, with each scaling face disposed perpendicular to the longitudinal axis 206 and extending circumferentially around the entire external sealing body 202. Each of the sealing faces may create a face seal against a shoulder or other surface of one of the first or second fluid tubes 214 and 217, as illustrated in FIG. 2A. Such a face seal may prevent fluid within the fluid path from escaping from the fluid path through the junction 224.

Referring additionally to FIG. 2B, a cross-sectional view of an example fluid sealing system 201 is illustrated. Fluid within the fluid path of the fluid system 201 may have a fluid pressure. As described above, the fluid pressure within the fluid path 213 may push against and force the internal scaling body 204 against the interior surfaces 221 and 223 of the first and second fluid orifices 215 and 218, such that the internal sealing body 204 creates a hermetic seal against such surfaces to prevent fluid within the fluid path 213 from escaping. In some situations, the larger fluid system, such as an ink cartridge or ink supply in which the fluid sealing system 201 may be disposed, may undergo or experience an external event that may cause the fluid pressure within the fluid path 213 to increase or spike. Such an external event may include an impact on, or dropping of the larger fluid system, or an external temperature change, among others. The increase in fluid pressure 228 may push against and force the internal sealing body 204 against the interior surfaces 221 and 223 of the first and second fluid orifices 215 and 218 to a larger degree or extent than without the increase in fluid pressure. As such, the increase in pressure 228 may increase the sealing force of the internal sealing body 204 against the interior surfaces 221 and 223, in other words, make the seal tighter, and further prevent fluid within the fluid path 213 from escaping through the junction 224. Additionally, the example fluid seal 200, and the external scaling body 202 and the internal sealing body 204 therein, may expand in size due to external or environmental stresses or factors. Upon such an expansion, the external sealing body 202 may provide a stronger contact and sealing force against the exterior surfaces 220 and 222, while the internal sealing body 204 may provide a stronger contact and sealing force against the interior surfaces 221 and 223. Thus, the scaling forces preventing fluid within the fluid path 213 from escaping through the junction 224 may increase and continue to prevent the fluid from escaping, when the fluid system 201 is exposed to external factors causing the expansion of the fluid seal 200.

What is claimed is:

1. A fluid seal, comprising:
an external scaling body; and
an internal scaling body disposed within the external scaling body,
wherein the internal sealing body is radially connected to the external sealing body by a webbing, and
wherein the external scaling body is to hermetically seal a fluid path from the exterior of the fluid path, while the internal scaling body is to hermetically seal the fluid path from within the interior of the fluid path.

2. The fluid seal of claim 1, wherein the fluid path comprises a first fluid orifice and a second fluid orifice in fluid communication with the first fluid orifice, and wherein the first and second fluid orifices each extends into the fluid seal from opposing sides of the fluid seal.

3. The fluid seal of claim 2, wherein the external sealing body is a cylindrical barrel, and the internal sealing body is a cylindrical barrel that is concentrically disposed within the external sealing body.

4. The fluid seal of claim 3, wherein the first fluid orifice is to extend into a cavity within the fluid seal in between the external sealing body and the internal sealing body in a direction towards the webbing.

5. The fluid seal of claim 4, wherein the second fluid orifice is to extend into an opposing cavity within the fluid seal in between the external sealing body and the internal scaling body in a direction towards an opposite side of the webbing from the first fluid orifice.

6. The fluid seal of claim 5, wherein the external sealing body and the internal scaling body provide a hermetic seal against an exterior surface and an interior surface of the fluid path, respectively, through an interference fit between the first and second fluid orifices, and the respective cavities in between the external sealing body and the internal sealing body.

7. The fluid seal of claim 6, wherein, upon a pressure increase within the fluid path, the internal sealing body is to provide a tighter seal against the interior surface of the fluid path than without the increase in pressure.

8. A fluid seal, comprising:
an external scaling boot having a tubular geometry;
a webbing disposed within the external sealing boot; and
an internal sealing boot having a tubular geometry and disposed within the external sealing boot,
wherein the webbing extends radially from the internal scaling boot to the external sealing boot, and
wherein the internal sealing boot extends from the webbing in both directions along a central longitudinal axis of the external sealing boot, and defines a cavity in between the internal sealing boot and the external sealing boot on one side of the webbing, and further defines an opposing cavity between the internal sealing boot and the external sealing boot on the opposing side of the webbing.

9. The fluid seal of claim 8, wherein the cavity and the opposing cavity are to receive a first and second fluid orifice, respectively, such that the first and second fluid orifices are in fluid communication with one another, and are both hermetically sealed in between the external scaling boot and the internal scaling boot.

10. The fluid seal of claim 9, wherein the internal sealing boot is disposed concentrically to the external sealing boot.

11. The fluid seal of claim 10, wherein the external scaling boot and the internal sealing boot both comprise a cylindrical tubular geometry.

12. A fluid sealing system, comprising:
a first fluid tube having a first fluid orifice;
a second fluid tube having a second fluid orifice concentrically aligned with and in fluid communication with the first fluid orifice; and
a fluid seal, comprising:
an external scaling boot disposed around the first and second fluid tubes; and
an internal sealing boot disposed within the first and second fluid orifices of the first and second fluid tubes,
wherein the internal sealing boot is concentrically disposed within the external sealing boot, and
wherein the external sealing boot and the internal sealing boot both extend and seal across a junction between the first and second fluid orifices such that the external and internal sealing bodies prevent fluid from escaping from the junction.

13. The fluid system of claim 12, wherein the fluid seal further comprises a webbing extending radially from the external sealing boot to the internal sealing boot and in between the first and second fluid orifices.

14. The fluid system of claim 13, wherein upon an increase of pressure within the first or second fluid tubes, the internal sealing boot is to provide a tighter seal across the junction than without the increase in pressure.

15. The fluid system of claim 14, wherein the fluid is printing ink.
